(19) United States
(12) Patent Application Publication
(10) Pub. No.: US 2006/0012482 A1
(43) Pub. Date: Jan. 19, 2006

(54) Radio frequency identification tag having an inductively coupled antenna

(76) Inventors: Peter Zalud, New Hope, PA (US); Jon Schepps, Princeton Jct., NJ (US)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 10/892,967

(22) Filed: Jul. 16, 2004

(51) Int. Cl. G08B 13/14

(52) U.S. Cl. 340/572.7; 235/492

(57) ABSTRACT

An RFID tag which couples a radiating element or antenna to an integrated circuit without a physical conductor. The radiating element comprises a coil. The integrated circuit is affixed to the substrate having the antenna in such a way that the circuit chip coil is inductively coupled to the antenna coil. When the RFID tag is excited via the antenna, the inductive coupling causes both signaling and power to couple from the antenna to the circuit chip coil without a physical conductor connecting the antenna to the RFID tag integrated circuit.

### FIELD OF THE INVENTION

The present invention relates to the field of radio-frequency identification (RFID) tags including, but not limited to, RFID tags having an inductively coupled antenna.

### BACKGROUND OF THE INVENTION

RFID tags and radio frequency identification tag systems are known, and find numerous uses. For example, RFID tags are frequently used for personal identification in automated gate sentry applications to protect and secure buildings or areas. Information stored on the RFID tag identifies the person seeking access to the building. An RFID tag system conveniently provides for reading the information from the RFID tag at a small distance using radio frequency data transmission technology. Typically, the user simply holds or places the radio frequency identification tag near a base station that transmits an excitation signal and communicates the stored information from the RFID tag through the base station, which receives and decodes the information. In general, RFID tags are capable of retaining and, in operation, transmitting a substantial amount of information. The information is typically sufficient to uniquely identify individuals, packages, inventory and the like.

A typical technology for powering and reading an RFID tag is to conductively couple an RFID antenna to a coil element in the RFID tag circuitry. The coil element is excited or energized via the conductors by an excitation signal from the base station to provide power to the RFID tag circuitry. The tag necessarily includes an antenna having at least one and frequently two antenna elements.

Coupling the antenna to the RFID chip usually involves using conductive pads. Such pads may be surface pads, recess pads or bump pads as desired. An example of conventional coupling technique using bonding pads is shown in U.S. Pat. No. 6,265,977, which also discusses typical RFID fabrication techniques. Further, U.S. Pat. No. 6,107,920 discloses another way of coupling the chip to the antenna by utilizing a layer of conductive adhesive to electrically couple the conductive pads to the antenna. Wire bonding and flip chip bonding are also utilized, as is discussed in U.S. Patent Publication U.S. 2002/0053735A1.

The limitation of all such known methods for coupling an RFID chip to an antenna is that such connections involve a conductive electrical connection. Such connections limit the ability to make cheaper and smaller RFID tags such that can be used in the most inexpensive applications. In the case of bonding pads, the size of a bonding pad is large relative to RFID circuitry. The savings of bonding pads would constitute significant savings of silicon area, which translates to reduction in fabrication cost. Further, the use of conductive connections requires that a portion of the chip have open passivation, further adding to the costs of the RFID tag. Moreover, conventional technique of using bonding pads does not work well in a semi-rigid or flexible structure such as a label or paper.

### SUMMARY OF THE INVENTION

An RFID tag according to the principles of the invention couples a radiating element or antenna on a substrate to an RFID tag integrated circuit without a physical conductor. The radiating element or antenna comprises a coil, also referred to as the antenna coil. Likewise, the integrated circuit has electronic circuitry connected to a coil also called the circuit chip coil. The integrated circuit is affixed to the substrate having the antenna in such a way that the circuit chip coil is inductively coupled to the antenna coil. When the RFID tag is excited via the antenna, the inductive coupling causes both signaling and power to couple from the antenna coil to the circuit chip coil without a physical conductor connecting the antenna to the RFID tag integrated circuit. Without limitation, the advantages of an RFID tag according to the principles of the invention can be significantly lower assembly costs, higher reliability, increased flexibility and ease of impedance matching between the integrated circuit and the antenna.

### BRIEF DESCRIPTION OF DRAWINGS

A more complete understanding of the invention may be obtained from consideration of the following description in conjunction with the drawings in which:

FIG. 1 is a diagrammatic view of an RFID tag according to the principles of the invention;

FIG. 2 shows an exemplary exploded view of the RFID tag in FIG. 1; and

FIG. 3 represents an exemplary view of assembled RFID tag according to the present invention.

FIG. 4 is a cross-sectional view of one embodiment of the RFID tag of FIG. 3, taken along line I-I in FIG. 3.

### DETAILED DESCRIPTION

Referring to FIG. 1, an RFID tag 100 according to the principles of the invention includes a radiating element or antenna 101 and an integrated circuit chip 102. The antenna 101 and chip 102 are placed within or upon a carrier or support 103. The carrier 103 can be a rigid substrate, or a semi-rigid or flexible material such as a sheet of paper or plastic. The radiating element 101 can communicate with both an outside antenna (not shown) and the integrated circuit 102 inside the RFID tag 100. The integrated circuit 102 comprises an electronic circuitry 104 and a coil 105 which is also called an integrated circuit coil. The integrated circuit 102 provides the primary identification functions. It can, for example, store the tag identification and other desirable information, interpret and process commands received from the interrogation hardware and respond to requests for information by the interrogator. Within the RFID tag 100, the radiating element 101 is inductively coupled to the integrated circuit coil 105, thereby providing signaling and power between the antenna coil 101 and the integrated circuit coil 105 without physically connecting them via a conductor. It is well known that an inductive coupling means the transfer of energy from one circuit to another by virtue of the mutual inductance between the circuits. Here, the integrated circuit 102 is attached to the carrier 103 such that the two coils form an inductive coupler, i.e., a core-less transformer.

The radiating element 101 can be produced by using a metal strip integrated into the carrier 103, or alternatively by using electrically conductive ink printed on the carrier such as a sheet of paper. An important aspect of the present invention is to enable an RFID tag to work well in a semi-rigid or flexible structure by eliminating the bonding pads. Furthermore, the assembly cost is reduced by elimination of the bonding pads and the flexibility in impedance matching between the integrated circuit and the radiating element is increased by using the inductive coupling. Compared to conventional bonding pads technique, the impedance matching for the inductive coupler can be easily achieved by changing the number of turns of both coils, or alternatively by changing the position of one coil relative to another.

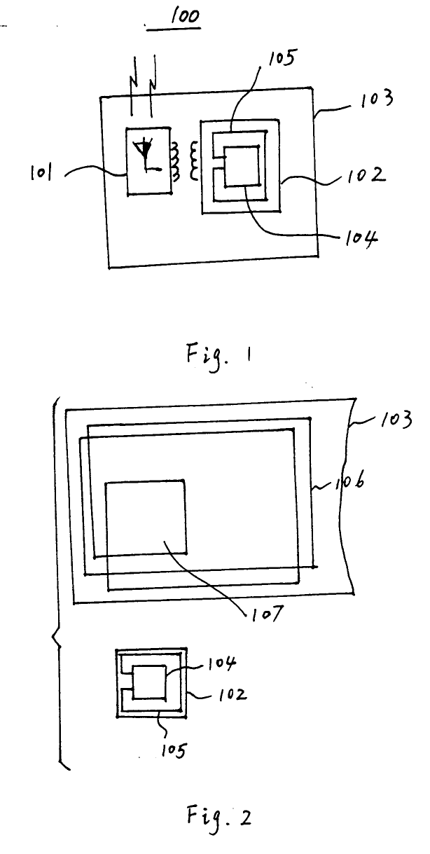

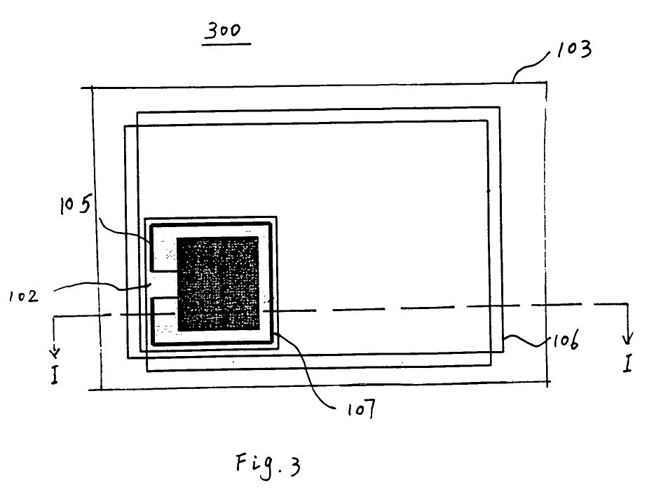

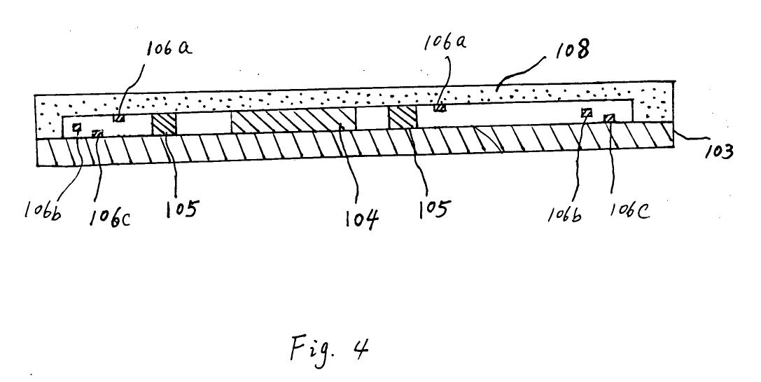

FIG. 2 shows an exploded view of the RFID tag in FIG. 1. An antenna coil 106 integrated with the carrier 103 has a core portion 107. The integrated circuit 102 comprising the integrated circuit coil 105 and electronic circuitry 104 can be mounted in the core portion 107 of the antenna coil 106, to form an inductive coupler (i.e., a coreless transformer). The electronic circuitry 104 is connected to a DC short circuit in the form of a wire coil 105. Preferably, the integrated circuit coil 105 has two or more turns depending on available number of metal layers used in the integrated circuit fabrication process. However, if desired, a single turn coil can be used. Likewise, the antenna coil 106 preferably is a multi-turn coil, but it can also be a single turn coil. Each turn of both antenna coil 106 and integrated circuit coil 105 can be fabricated on a layer of the integrated circuit or printed on a layer of the substrate using electrical conductive ink. An assembled RFID tag 300 according to the principles of the invention is shown in FIG. 3. It can be seen clearly that the integrated circuit chip 102 having integrated circuit coil 105 is mounted substantially in the center of the core portion 107 of antenna coil 106.

FIG. 4 is a cross-sectional view of on embodiment of the RFID tag 300 of FIG. 3, taken along line I-I in FIG. 3. The electrical circuitry 104 having integrated circuit coil 105 and antenna coil 106 are placed on the cover 103. As best seen in FIG. 4, the integrated circuit coil 105 inductively couples to the antenna coil 106, and no wire bonds are used for connecting the two coils. The antenna coil 106 can be disposed in different levels in the RFID tag, for example, as shown at 106a, 106b and 106c, respectively. The electrical circuitry 104 is surrounded by the antenna coil 106. A cover layer 108 is used to seal electrical circuitry 104, integrated coil 105 and antenna coil 106. The cover layer, for example, can be a closed passivation layer. Because no open passivation for the integrated circuit chip are used, the costs of the RFID tag can be saved. Suitable materials for cover layer 108 include paper, acetate, polyester, plastic, electrically insulating tape and other nonconductive materials. In this embodiment, antenna coil 106 has two turns, but it can use more than two turns or a single turn.

In accordance with the present invention, there has been described a method for coupling a radiating element or antenna to an RFID tag integrated circuit without a physical conductor. The integrated circuit is affixed to the substrate having the antenna in such a way that the circuit chip coil is inductively coupled to the antenna coil. When the RFID tag is excited via the antenna, the inductive coupling causes both signaling and power to couple from the antenna to the circuit chip coil without a physical conductor connecting the antenna to the RFID tag integrated circuit. Advantageously, the present invention significantly lowers assembly costs by eliminating the bonding pads process. The flexibility in impedance matching between the integrated circuit and the radiating element is increased by using inductive coupling. Moreover, the RFID tag according to the present invention has higher reliability.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications which come within the scope of the appended claim is reserved.

What is claimed is:

1. An RFID tag comprising:
a radiating element including a radiating element coil; and
an integrated circuit chip having a coil coupled to the integrated circuitry;
wherein the integrated circuit chip inductively couples to radiating element coil via the circuit chip coil.

2. The RFD tag of claim 1 wherein the radiating element comprises a conductive ink.

3. The RFID tag of claim 1 wherein the radiating element coil is a single turn coil.

4. The RFID tag of claim 1 wherein the radiating element coil comprises a multi-turn coil.

5. The RFID tag of claim 1 wherein the integrated circuit is mounted substantially in the center of the radiating element coil.

6. The RFID tag of claim 1 wherein the integrated circuit coil is a single turn coil.

7. The RFID tag of claim 1 wherein the integrated circuit coil is a multi-turn coil.

8. The RFID tag of the preceding claim wherein each turn of the multi-turn coil is fabricated on a layer of the integrated circuit.

9. The RFID tag of claim 1 wherein the integrated circuit coil and the radiating element coil form a core-less transformer.

10. The RFID tag of claim 1 wherein the integrated circuit chip includes a closed pavssivation layer.

11. The RFID tag of claim 1 wherein the integrated circuit chip couples to the radiating element in the absence of bonding pads.

12. A method for exciting an RFID tag comprising the steps of:
delivering excitation energy to a radiating element of the RFID tag and inductively coupling the energy from the radiating element to an RFID tag integrated circuit.

13. The method of claim 10 wherein the inductive coupling step is carried out via a coreless transformer.

14. A method for fabricating an RFID tag comprising the steps of:
disposing an antenna on a carrier, the antenna including a coil;
mounting an integrated circuit having an integrated circuit coil to the carrier such that the antenna coil and integrated circuit coil can inductively couple at least an excitation signal via the antenna coil.
